(19) United States
(12) Patent Application Publication
(10) Pub. No.: US 2011/0231750 A1
(43) Pub. Date: Sep. 22, 2011

(54) EFFECT DETECTION DEVICE, EFFECT DETECTION METHOD AND COMPUTER READABLE MEDIUM

(75) Inventor: Masaya NAITO, Kawasaki (JP)

(73) Assignee: FUJITSU LIMITED, Kawasaki-shi (JP)

(21) Appl. No.: 13/031,606

(22) Filed: Feb. 21, 2011

(30) Foreign Application Priority Data
Mar. 18, 2010 (JP) 2010-062664

(51) Int. Cl. G06F 17/00

(52) U.S. Cl. 715/234

(57) ABSTRACT

An effect detection device includes: a first extraction unit configured to compare first document-structure definition information with second document-structure definition information, and extract at least one of an element added to the first document-structure definition information, an element changed in the first document-structure definition information, and an element deleted from the first document-structure definition information; a second extraction unit configured to extract an element which is in a parent-child relationship or a sibling relationship with an element extracted by the first extraction unit from hierarchy definition documents defining a relation between elements with a hierarchy structure, the hierarchy definition documents being provided to the first document-structure definition information and the second document-structure definition information respectively; and a detection unit configured to detect and output items defined by using at least one of the element extracted by the first extraction unit and an element extracted by the second extraction unit.

### CROSS-REFERENCE TO RELATED APPLICATION

This application is based upon and claims the benefit of priority of the prior Japanese Patent Application No. 2010-062664, filed on Mar. 18, 2010, the entire contents of which are incorporated herein by reference.

### FIELD

The embodiments discussed herein are related to an effect detection device, an effect detection method, and a computer readable medium.

### BACKGROUND

Recently, in order to enhance the smooth distribution of the financial information, specification of eXtensible Business Reporting Language (XBRL) based on eXtensible Markup Language (XML) is enacted by the XBRL International, and the use of the financial data based on the specification of XBRL is advancing around the financial institutions such as the bank and the like. In XBRL, for example, data itself such as sales and operating profit is included in a file, which is called an instance document, and for example, a display structure, a display method and the like are included in a file, which is called a taxonomy.

Techniques for loading financial information described in XBRL into a database and performing an analysis of the financial information and the like are developed as disclosed in Japanese Laid-open Patent Publication No. 2007-164591 for example. When the analysis of the financial information described in XBRL is performed, a mapping between items defined in a taxonomy and code schemes managed in the database is performed. In addition, it is possible to describe formulas for value verifications of the instance document or formulas for financial calculation to a taxonomy by using the Formula Linkbase technique, and use them for the analysis and the like. Formula Linkbase is an international standard specification based on the XBRL specification for checking the value of the instance document and defining calculations for the financial analysis.

Mapping definitions that specify mappings between items defined in a taxonomy and code schemes managed in a database, and formula definitions that define calculating formulas in the taxonomy are created for a certain taxonomy such as a standard taxonomy provided by a government agency handling finance (e.g. Financial Services Agency in Japan) and the like. However, depending on companies, there is a case that the use of items undefined in the standard taxonomy is desired. In such case, a company creates a taxonomy which is called an extension taxonomy which includes company-specific items. Moreover, there is a case that the standard taxonomy itself is modified according to the revision of laws, ordinances and regulations and the like.

When the analysis using an extension taxonomy or a modified taxonomy is performed, it is necessary to check if the above modification affects mapping definitions and formula definitions created for a certain taxonomy.

Generally, there is a case that thousands of items are defined in the taxonomy, and there is a case that hundreds of relations and verification/calculating formulas are defined in mapping definitions and formula definitions. Therefore, it takes a lot of time to review hundreds of mapping definitions and verification/calculating formulas one by one, and verify the degree of effect, and mistakes may occur. A technique that indicates parts affected by the modification/change when the program is modified or changed is suggested as disclosed in Japanese Laid-open Patent Publication No. 7-281883 for example.

However, information regarding display relations, calculation relations and the like are included in a taxonomy in addition to the definition of items. Therefore, as it becomes complicated to extract data relating to each other, it is difficult to apply the technique disclosed in Japanese Laid-open Patent Publication No. 7-281883 directly.

### SUMMARY

According to an aspect of the embodiment, there is provided an effect detection unit including: a first extraction unit configured to compare first document-structure definition information with second document-structure definition information, and extract at least one of an element added to the first document-structure definition information, an element changed in the first document-structure definition information, and an element deleted from the first document-structure definition information, the first document-structure definition information and the second document-structure definition information defining a structured document; a second extraction unit configured to extract an element which is in a parent-child relationship or a sibling relationship with an element extracted by the first extraction unit from hierarchy definition documents defining a relation between elements with a hierarchy structure, the hierarchy definition documents being provided to the first document-structure definition information and the second document-structure definition information respectively; and a detection unit configured to detect and output items defined by using at least one of the element extracted by the first extraction unit and an element extracted by the second extraction unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an outline of a taxonomy;

FIG. 2 is a diagram illustrating a system configuration including an effect detection device in accordance with an embodiment;

FIGS. 3A through 3C are diagrams illustrating a combination of a comparison-source taxonomy and a comparison-subject taxonomy, mapping definitions, and verification/calculating formulas;

FIG. 4 is a functional block diagram illustrating units achieving functions provided to the effect detection device;

FIG. 5 is a flowchart illustrating an effect detection process;

FIGS. 6A through 6C illustrate specific data for explaining the effect detection process;

FIG. 7 is a flowchart illustrating a process of extracting a parent element and a sibling element;

FIG. 8 illustrates a Calculation link included in the comparison-source taxonomy;

FIG. 9 illustrates a Calculation link included in the comparison-subject taxonomy;

FIG. 10 is a flowchart illustrating a process of extracting formulas to be affected;

FIGS. 11A and 11B are diagrams illustrating a result of the effect detection;

FIG. 12 is a diagram illustrating another configuration of the effect detection device; and

FIGS. 13A and 13B are diagrams illustrating a method for displaying a result of an effect detection.

### DESCRIPTION OF EMBODIMENTS

A description will be given of embodiments with reference to the accompanying drawings.

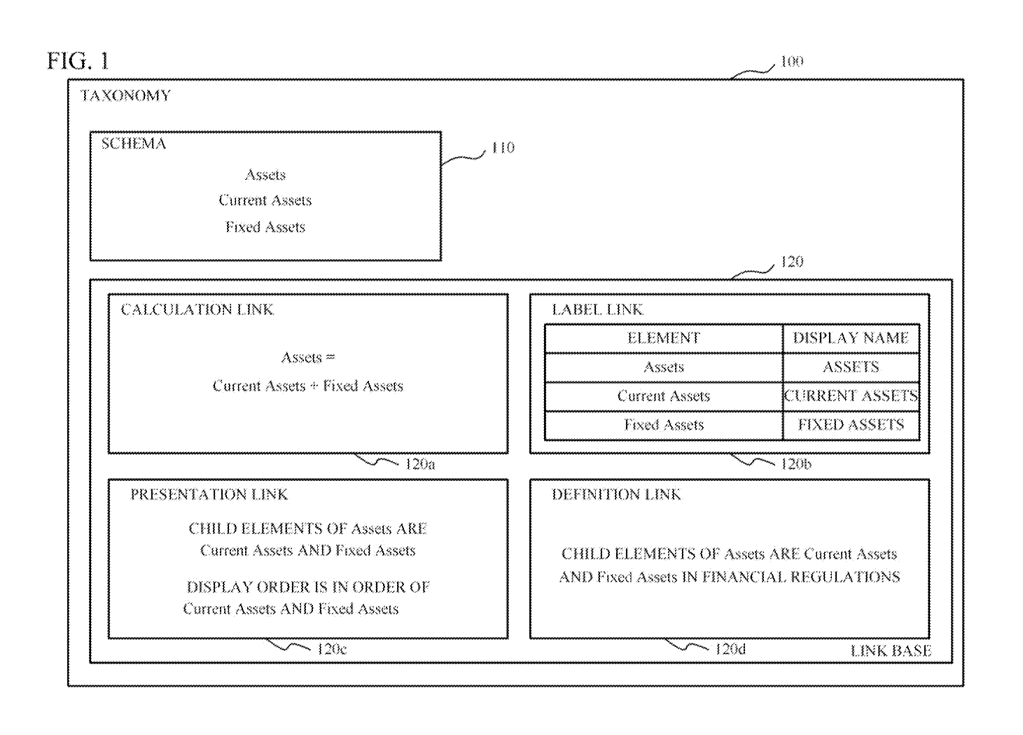

A description will now be given of an outline of a taxonomy with reference to FIG. 1. A taxonomy 100 includes a schema 110 and a linkbase 120.

The schema 110 defines items (elements) which are used in the taxonomy. In FIG. 1, the schema 110 defines “Assets”, “Current Assets” and “Fixed Assets” as elements used in the taxonomy.

The linkbase 120 is a document describing a relation (link) between elements used in the taxonomy. The linkbase 120 includes a Calculation link 120a, a Label link 120b, a Presentation link 120c and a Definition link 120d. The Calculation link 120a defines calculation relations between elements. In FIG. 1, the Calculation link 120a defines a calculation relation that the element “Assets” defined in the schema 110 is the sum of “Current Assets” and “Fixed Assets”, “Current Assets” and “Fixed Assets” being also defined in the schema 110.

The Label link 120b defines a display name for an element. In FIG. 1, the Label link 120b relates display names “assets”, “current assets” and “fixed assets” to elements “Assets”, “Current Assets” and “Fixed Assets” defined in the schema 110 respectively.

The Presentation link 120c defines a parent-child relationship and a display order in a case where elements defined in the schema 110 are displayed. In FIG. 1, the Presentation link 120c defines “Current Assets” and “Fixed Assets” as child elements of “Assets”, and defines the display order as the order of “Current Assets” and “Fixed Assets” when elements are displayed.

The Definition link 120d defines a parent-child relationship between elements defined in the schema 110 for example. In FIG. 1, the Definition link 120d defines a parent-child relationship that child elements of “Assets” are “Current Assets” and “Fixed Assets” in financial regulations.

It is possible to create financial information based on the taxonomy 100 described above and the instance document describing a value of each element (e.g. Assets=100).

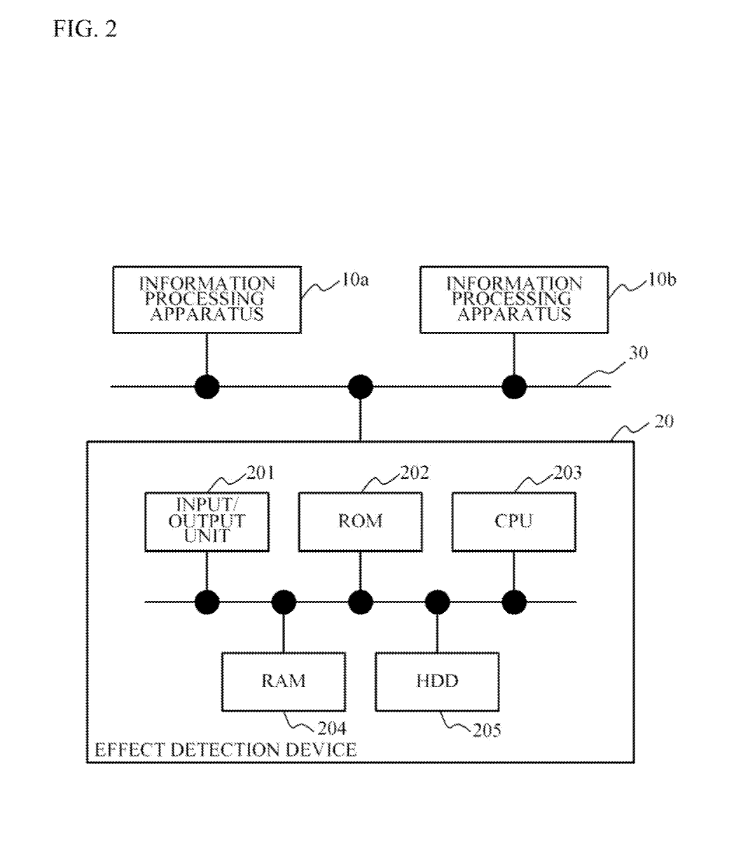

A description will now be given of a system including an effect detection device in accordance with the present embodiment. FIG. 2 is a diagram illustrating a system configuration including the effect detection device in accordance with the present embodiment. As illustrated in FIG. 2, an effect detection device 20 is coupled to information processing apparatuses 10a and 10b via a network 30.

Information processing apparatuses 10a and 10b are personal computers for example. Information processing apparatuses 10a and 10b display a taxonomy stored in the effect detection device 20 on a display device provided to information processing apparatuses 10a and 10b in response to a user input. When the taxonomy is modified, information processing apparatuses 10a and 10b transmit an executive instruction for executing an effect detection process detecting the effect by a modification of the taxonomy to the effect detection device 20 in response to a user input. In addition, information processing apparatuses 10a and 10b receive the result of the effect detection process executed by the effect detection device 20, and display the result on the display device.

The effect detection device 20 is a server computer having information processing apparatuses 10a and 10b as client computers for example. When the effect detection device 20 receives an executive instruction of the effect detection process from the information processing apparatus 10a or 10b, it executes the effect detection process. The effect detection device 20 transmits the result of the effect detection process to the information processing apparatus 10a or 10b.

The effect detection device 20 is provided with an input/output unit 201, a ROM (Read Only Memory) 202, a CPU (Central Processing Unit) 203, a RAM (Random Access Memory) 204, and an HDD (Hard Disk Drive) 205.

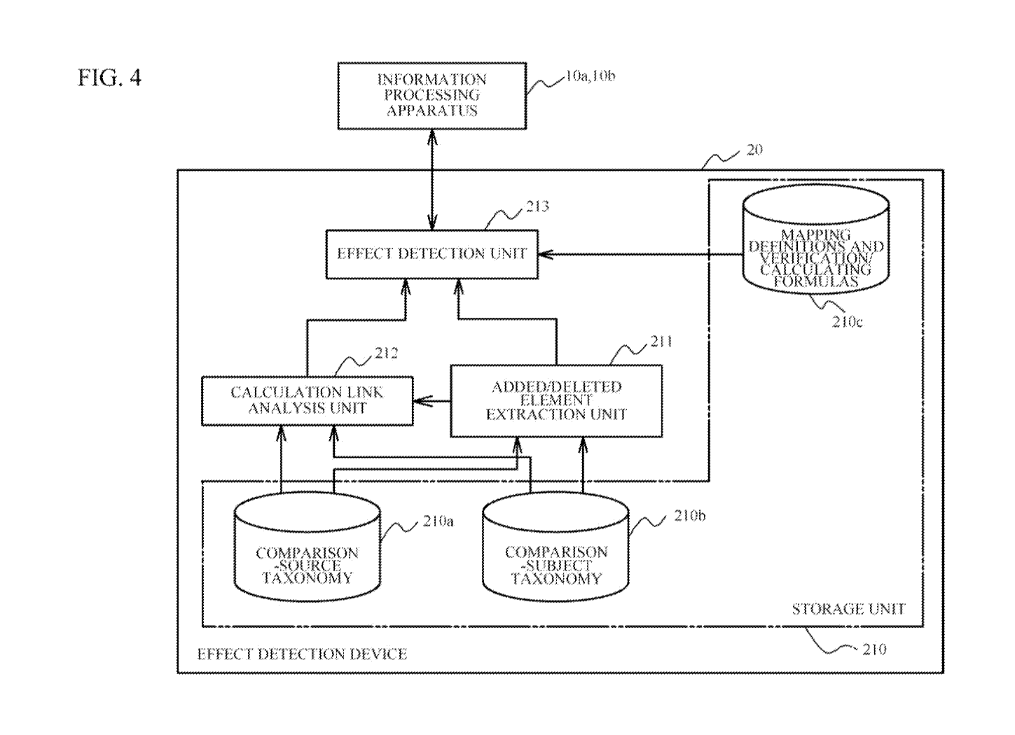

The input/output unit 201 receives and transmits data and signals from/to information processing apparatuses 10a and 10b. The ROM 202 stores programs to execute the effect detection process and the like. The CPU 203 reads and executes programs stored in the ROM 202. The RAM 204 stores temporary data used in executing programs. Functions that an added/deleted element extraction unit 211, a Calculation link analysis unit 212, and an effect detection unit 213 illustrated in FIG. 4 have are executed by the execution of programs stored in the ROM 202 by the CPU 203.

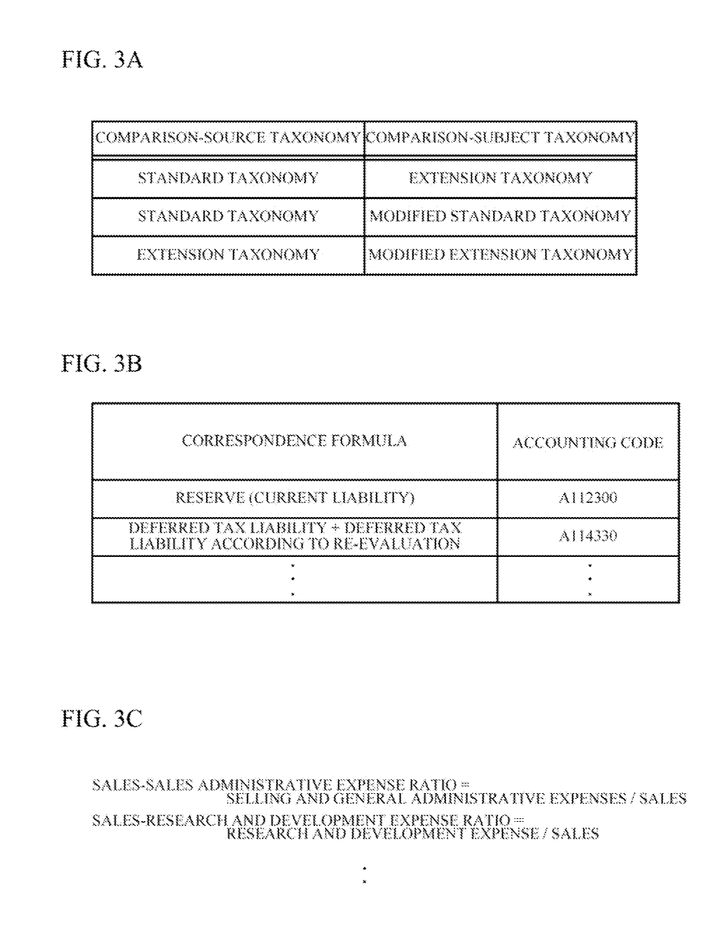

The HDD 205 stores a comparison-source taxonomy (first document-structure definition information), a comparison-subject taxonomy (second document-structure definition information), mapping definitions and verification/calculating formulas. The comparison-source taxonomy is a taxonomy which becomes a comparison-source in a case where the effect detection device 20 executes the effect detection process. The comparison-subject taxonomy is a taxonomy which is compared to the comparison-source taxonomy, and becomes the subject for the effect detection. For example, the comparison-source taxonomy is a standard taxonomy provided from the Financial Services Agency. In this case, the comparison-subject taxonomy may be an extension taxonomy to which a company adds company-specific items, or a standard taxonomy which is modified according to the revision of laws, ordinances and regulations. When the comparison-source taxonomy is an extension taxonomy, the comparison-subject taxonomy may be an extension taxonomy created by adding new elements to the extension taxonomy which is the comparison-source taxonomy. In FIG. 3A, combinations of a comparison-source taxonomy and a comparison-subject taxonomy are indicated.

Mapping definitions relate one or more elements used in the comparison-source taxonomy to items that a user uniquely sets in a database and the like. FIG. 3B illustrates an example of mapping definitions. Mapping definitions of the present embodiment include “correspondence formula” and “accounting code”. A formula using one or more elements defined in the comparison-source taxonomy is defined in the “correspondence formula”. An accounting code in a database which is a subject for mapping is defined in the “accounting code”. In FIG. 3B, “reserve (current debt)” which is an element of the comparison-source taxonomy is mapped to an accounting code “A112300”. The sum of “deferred tax liability” and “deferred tax liability according to re-evaluation” is mapped to an accounting code “A114330”.

Verification/calculating formulas are formulas using elements of the comparison-source taxonomy. For example, one of verification/calculating formulas is a formula to calculate a sales-sales administrative expense ratio from “selling and general administrative expenses” and “sales” which are elements of the comparison-source taxonomy as illustrated in FIG. 3C. Moreover, one of verification/calculating formulas is a formula to calculate a sales-research and development expense ratio from “research and development expense” and “sales” which are elements of the comparison-source taxonomy.

The network 30 is a communication means such as LAN (Local Area Network) and WAN (Wide Area Network). The network 30 transfers data transmitted from information processing apparatuses 10a and 10b, and the effect detection device 20 to the destination.

A description will now be given of units to achieve functions provided to the effect detection device 20, with reference to FIG. 4. FIG. 4 is a functional block diagram illustrating units to achieve functions provided to the effect detection device 20.

The effect detection device 20 is provided with a storage unit 210, the added/deleted element extraction unit 211 (first extraction unit), the Calculation link analysis unit 212 (second extraction unit), and the effect detection unit 213 (detection unit).

The storage unit 210 may be the HDD 205 for example. A comparison-source taxonomy 210a, a comparison-subject taxonomy 210b, and mapping definitions and verification/calculating formulas 210c are stored in the storage unit 210.

The added/deleted element extraction unit 211 compares the comparison-source taxonomy 210a with the comparison-subject taxonomy 210b, and extracts elements which are added to, deleted from or changed from the comparison-source taxonomy 210a. More specifically, when the comparison-source taxonomy is a standard taxonomy and the comparison-subject taxonomy is an extension taxonomy, an element list included in the extension taxonomy is obtained. The element list is a document describing only elements to be added to the standard taxonomy in the extension taxonomy. Assume that the comparison-source taxonomy is a standard taxonomy or an extension taxonomy and the comparison-subject taxonomy is a modified taxonomy or a modified extension taxonomy. In this case, the added/deleted element extraction unit 211 compares a schema of the comparison-source taxonomy with a schema of the comparison-subject taxonomy, and extracts a list of elements which are added, deleted or changed. The added/deleted element extraction unit 211 outputs extracted elements to the Calculation link analysis unit 212 and the effect detection unit 213.

The Calculation link analysis unit 212 obtains respective Calculation links (hierarchy definition documents) included in the comparison-source taxonomy 210a and the comparison-subject taxonomy 210b. Moreover, the Calculation link analysis unit 212 receives elements extracted by the added/deleted element extraction unit 211 from the added/deleted element extraction unit 211. The Calculation link analysis unit 212 extracts elements which have a parent-child relationships or a sibling relationships with elements extracted by the added/deleted element extraction unit 211 by using Calculation links. Hereinafter, an element having a parent-child relationship with an extracted element is referred to as a parent element, and a element having a sibling relationship with an extracted element is referred to as a sibling element. The Calculation link analysis unit 212 outputs a parent element and a sibling element, which are extracted, to the effect detection unit 213.

The effect detection unit 213 obtains mapping definitions and verification/calculating formulas 210c from the storage unit 210. The effect detection unit 213 receives elements extracted by the Calculation link analysis unit 212 and the added/deleted element extraction unit 211. The effect detection unit 213 extracts a mapping definition or a verification/calculating formula using received elements, and outputs a result of the extraction to the information processing apparatus 10a or 10b. The information processing apparatus 10a or 10b displays the received result of the effect detection on the display device.

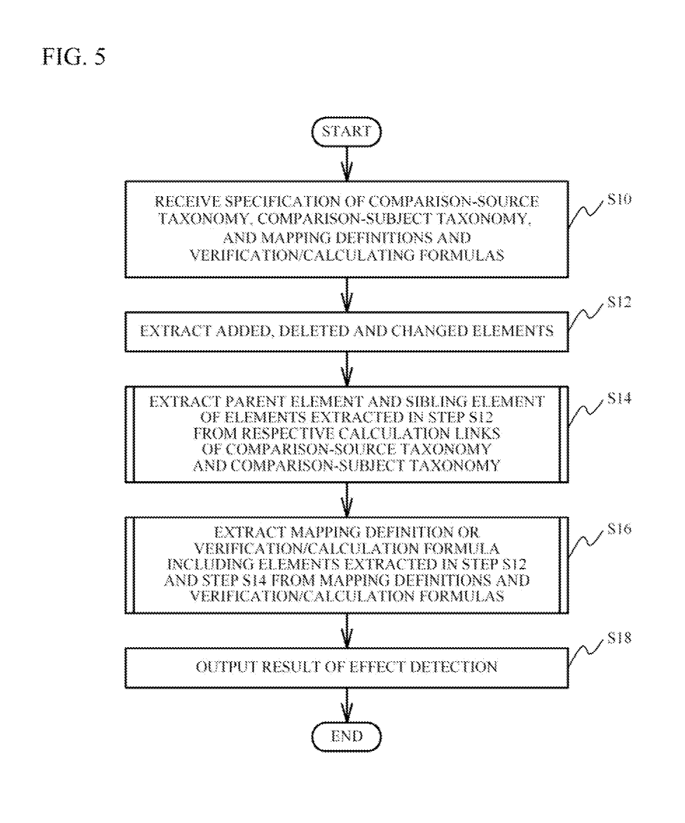

A description will now be given of an effect detection process executed by the effect detection device 20 using a specific example, with reference to FIG. 5 through FIG. 11. FIG. 5 is a flowchart illustrating an effect detection process executed by the effect detection device 20.

The effect detection device 20 receives a specification of the comparison-source taxonomy, the comparison-subject taxonomy, and mapping definitions and verification/calculating formulas through the information processing apparatus 10a or 10b (step S10).

The added/deleted element extraction unit 211 compares the comparison-source taxonomy with the comparison-subject taxonomy, and extracts elements that are added, deleted or changed (step S12).

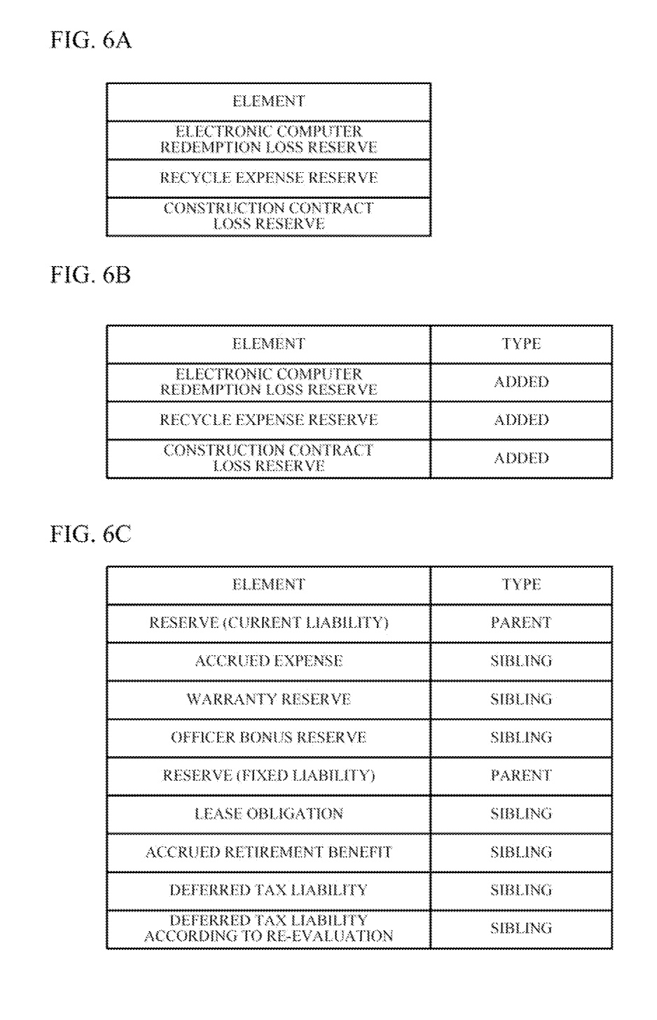

In the specific example, assume that the comparison-source taxonomy is a standard taxonomy, and the comparison-subject taxonomy is an extension taxonomy. In addition, a user specifies mapping definitions as the subject of detection of the degree of effect. Moreover, elements defined in a element list of the extension taxonomy are “electronic computer redemption loss reserve”, “recycle expense reserve”, and “construction contract loss reserve” illustrated in FIG. 6A. In this case, after the execution of the step S12, above three elements are extracted with “type” that indicates whether the element is added, deleted or changed as illustrated in FIG. 6B. In the specific example, since all elements are added, “added” is registered in the “type”.

In a flowchart illustrated in FIG. 5, the Calculation link analysis unit 212 extracts a parent element and a sibling element of elements extracted in the step S12 by using respective Calculation links included in the comparison-source taxonomy and the comparison-subject taxonomy (step S14).

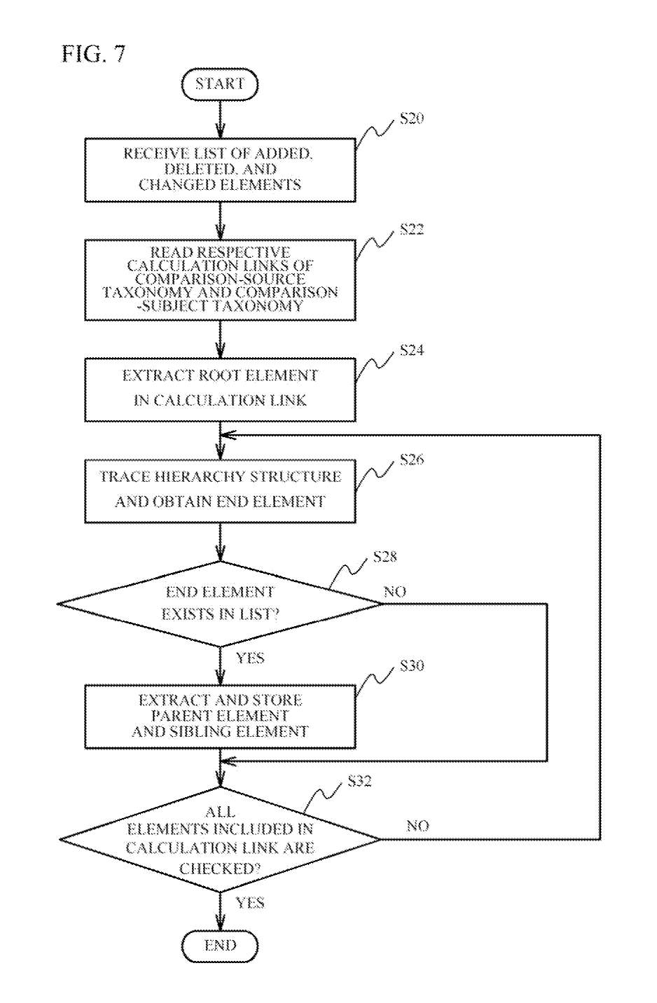

With reference to FIG. 7, a description will now be given of a detail process of the step S14. FIG. 7 is a flowchart illustrating a process of the step S14.

The Calculation link analysis unit 212 receives a list of elements, which are added, deleted or changed, from the added/deleted element extraction unit 211 (step S20). Then, the Calculation link analysis unit 212 reads respective Calculation links from the comparison-source taxonomy and the comparison-subject taxonomy (step S22).

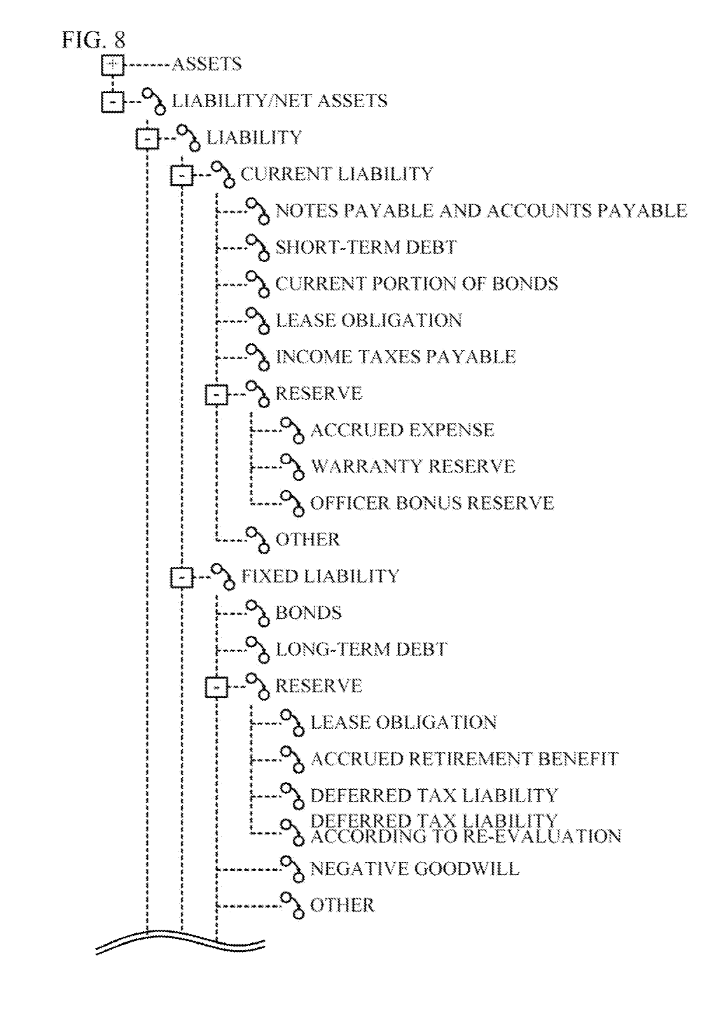

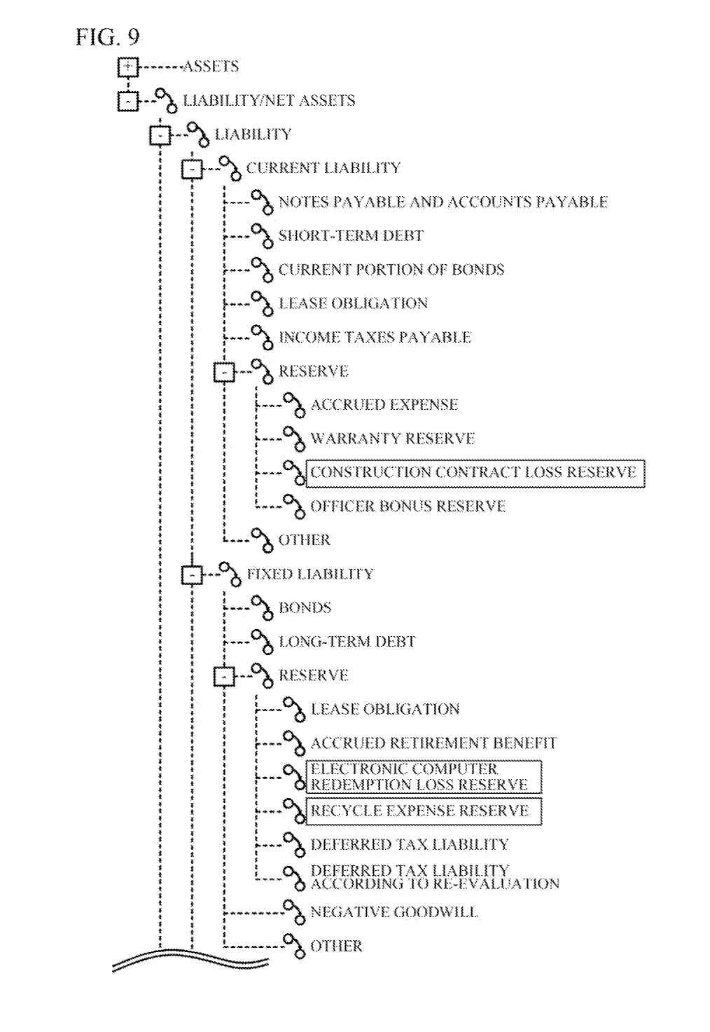

FIG. 8 and FIG. 9 illustrate respective Calculation links included in the comparison-source taxonomy and the comparison-subject taxonomy. Using a Calculation link illustrated in FIG. 8, a description will be given of a parent-child relationship and a sibling relationship between elements.

In FIG. 8, an element “current liability” is connected to an element “liability” and is located in one lower tier from the element “liability”. In this case, the element “liability” to which “current liability” is connected and which locates in one upper tier of “current liability” is a parent element of “current liability”. Moreover, an element “fixed reliability” which is connected to “liability” and is located in one lower tier from “liability” as well as “current liability”, which means that the “fixed liability” locates in the same tier as the “current liability”, is a sibling element of “current liability”.

In the same manner, for example, regarding “accrued expense”, “reserve (current liability)” is a parent element of “accrued expense”, and “warranty reserve” and “officer bonus reserve” are sibling elements of “accrued expense”.

In the flowchart illustrated in FIG. 7, the Calculation link analysis unit 212 extracts a root element in the Calculation link (step S24). The root element is an element which locates in the top of the hierarchy in the Calculation link. This means that the root element does not have a parent element. The Calculation link analysis unit 212 traces a hierarchy structure from a root element, and obtains an element which has no lower tier (referred to as an end element) (step S26). Then, the Calculation link analysis unit 212 determines whether the obtained end element exists in the list received in the step S20 (step S28). When the element does not exist in the list (step S28/NO), the Calculation link analysis unit 212 determines whether all elements included in the Calculation link are checked (step S32). When all elements are not checked (step S32/NO), the Calculation link analysis unit 212 goes back to the step S26, and continues the process. When all elements included in the Calculation link are checked (step S32/YES), the Calculation link analysis unit 212 ends the process.

When the obtained element exists in the list received in the step S20 (step S28/YES), the Calculation link analysis unit 212 extracts a parent element and a sibling element of the obtained element as elements to be affected, and stores them in the RAM 204, the HDD 205 or the like (step S30).

The Calculation link analysis unit 212 determines whether all elements included in the Calculation link are checked (step S32). When all elements are not checked (step S32/NO), the Calculation link analysis unit 212 goes back to the step S26 and continues the process. When all elements included in the Calculation link are checked (step S32/YES), the Calculation link analysis unit 212 ends the process.

In the specific example, the Calculation link analysis unit 212 extracts a root element in the Calculation link of the extension taxonomy illustrated in FIG. 9 (step S24). Elements “assets” and “liability/net assets” that locate in the top of the hierarchy are root elements in the Calculation link illustrated in FIG. 9. Here, a description will be given using a root element “liability/net assets” in this specific example.

The Calculation link analysis unit 212 traces a hierarchy structure from the root element, and extracts an end element (step S26). In FIG. 9, as tracing a hierarchy structure from “liability/net assets”, an end element appearing first is “notes payable and accounts payable”. The Calculation link analysis unit 212 obtains the end element “notes payable and accounts payable” (step S26), and determines whether the element “notes payable and accounts payable” exists in the list illustrated in FIG. 6B (step S28). As “notes payable and accounts payable” does not exist in the list illustrated in FIG. 6B (step S28/NO), the Calculation link analysis unit 212 determines whether all elements included in the Calculation link are checked (step S32). As all elements are not checked yet (step S32/NO), the Calculation link analysis unit 212 obtains a next end element (step S26). In FIG. 9, the next end element is “short-term debt”, and “short-term debt” does not exist in the list in FIG. 6B (step S28/NO). Thus, the Calculation link analysis unit 212 repeats procedures of steps S28, S32 and S26.

The Calculation link analysis unit 212 repeats above procedures, and obtains “construction contract loss reserve” as an end element (step S26). Then, the Calculation link analysis unit 212 determines whether “construction contract loss reserve” exists in the list illustrated in FIG. 6B (step S28). “Construction contract loss reserve” exists in the list illustrated in FIG. 6B (step S28/YES). Thus, the Calculation link analysis unit 212 extracts “reserve (current liability)”, which is a parent element of “construction contract loss reserve”, and “accrued expense”, “warranty reserve” and “officer bonus reserve” which are sibling elements, and stores them (step S30). As there are elements which are not checked yet (step S32/NO), the Calculation link analysis unit 212 goes back to the step S26, and continues the process.

When the process is continued and the Calculation link analysis unit 212 obtains “electronic computer redemption loss reserve” as an end element (step S26), the determination of the step S28 becomes YES. Then, the Calculation link analysis unit 212 extracts “reserve (fixed liability)”, which is a parent element of “electronic computer redemption loss reserve”, and “lease obligation”, “accrued retirement benefit”, “recycle expense reserve”, “deferred tax liability” and “deferred tax liability according to re-evaluation”, which are sibling elements, and stores them (steps S30). As “recycle expense reserve” exists in the list illustrated in FIG. 6B, it may be possible not to extract “recycle expense reserve” as a sibling element.

In the same manner, as “recycle expense reserve” exists in the list illustrated in FIG. 6B (step S28/YES), the Calculation link analysis unit 212 extracts a parent element and a sibling element and stores them (step S30). A parent element and a sibling element of “recycle expense reserve” overlap with a parent element and a sibling element of “electronic computer redemption loss reserve”. In this case, overlapping element may be excluded from the result of the extraction.

FIG. 6C illustrates the result of extracting a parent element and a sibling element output from the Calculation link analysis unit 212 as a result of the process described in the flowchart illustrated in FIG. 7 in the specific example. The “type” in FIG. 6C indicates whether the element written in the left side is a parent element or a sibling element to the element illustrated in FIG. 6B.

In the specific example, as all elements extracted by the added/deleted element extraction unit 211 are added elements, a parent element and a sibling element are extracted by using a Calculation link included in the extension taxonomy which is the comparison-subject taxonomy. The Calculation link analysis unit 212 extracts a parent element and a sibling element by using a Calculation link included in the comparison-source taxonomy when elements extracted by the added/deleted element extraction unit 211 are deleted elements. In addition, the Calculation link analysis unit 212 extracts a parent element and a sibling element by using respective Calculation links included in the comparison-source taxonomy and the comparison-subject taxonomy when elements extracted by the added/deleted element extraction unit 211 are changed elements.

Back to the flowchart in FIG. 5, a description will be continued. In FIG. 5, the effect detection unit 213 extracts a mapping definition and a verification/calculating formula defined by elements extracted in the step S12 and the step S14 from specified mapping definitions and verification/calculating formulas (step S16).

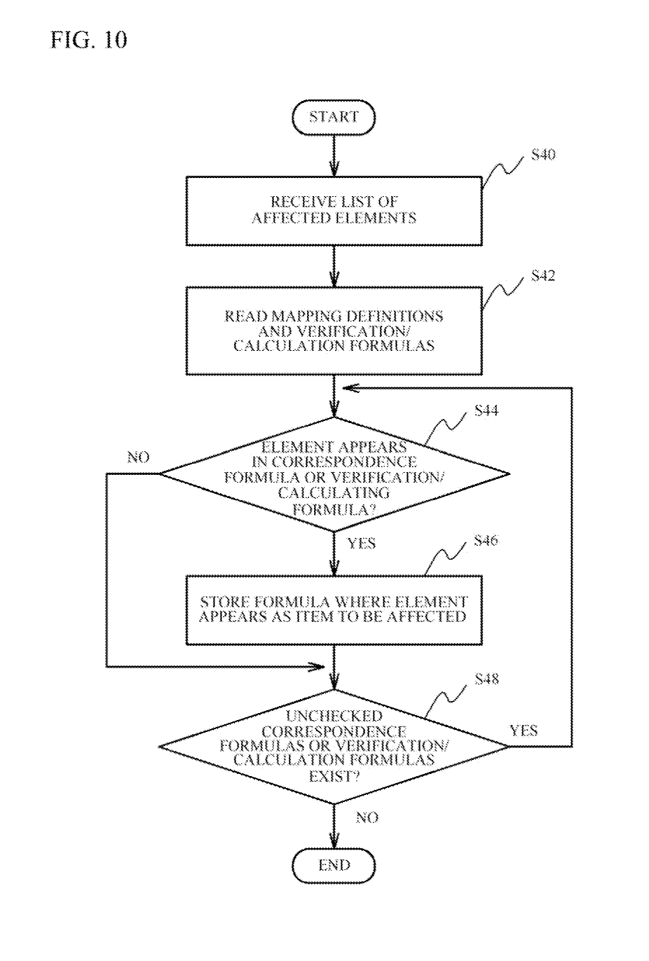

A description will now be given of the process of the step S16 in detail. FIG. 10 is a flowchart illustrating a detail process of the step S16.

The effect detection unit 213 receives a list of added, deleted and changed elements from the added/deleted element extraction unit 211 as a list of elements to be affected. In addition, the effect detection unit 213 receives a list of a parent element and a sibling element from the Calculation link analysis unit 212 as a list of elements to be affected (step S40). Then, the effect detection unit 213 reads mapping definitions and verification/calculating formulas specified by the user (step S42).

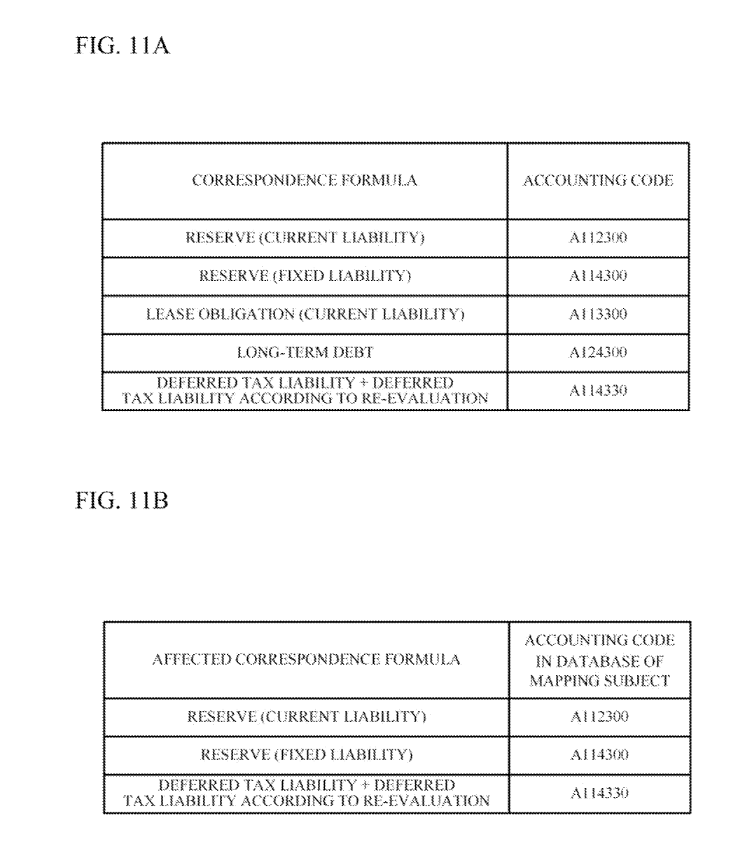

In the specific example, the effect detection unit 213 receives a list illustrated in FIG. 6B from the added/deleted element extraction unit 211, and a list illustrated in FIG. 6C from the Calculation link analysis unit 212 (step S40). Moreover, in the specific example, assume that mapping definitions illustrated in FIG. 11A are specified by the user.

In a flowchart illustrated in FIG. 10, the effect detection unit 213 determines whether elements included in the list received in the step S40 appear in a mapping definition or a verification/calculating formula (step S44). This means that it is determined whether a mapping definition or a verification/calculating formula (item) defined by using at least one of elements extracted by the added/deleted element extraction unit 211 and the Calculation link analysis unit 212 exists.

When the determination of the step S44 is YES, the effect detection unit 213 obtains the mapping definition or the verification/calculating formula as an item to be affected, and stores it (step S46). Then, the effect detection unit 213 determines whether there are mapping definitions that are not checked yet to see whether elements included in the list received in the step S40 appear (step S48). When the determination of the step S48 is NO, the effect detection unit 213 ends the process. On the other hand, when the determination of the step S48 is YES, the effect detection unit 213 goes back to the step S44 and continues the process.

When the determination of the step S44 is NO, the effect detection unit 213 executes the process of the step S48 described above.

In the specific example, the effect detection unit 213 determines whether elements included in lists illustrated in FIGS. 6B and 6C appear in the correspondence formula of mapping definitions illustrated in FIG. 11A (step S44).

The element “reserve (current liability)” used in the correspondence formula of the record in the first line in FIG. 11A appears in the list illustrated in FIG. 6C (step S44/YES). Therefore, the effect detection unit 213 stores the record in the first line as the item to be affected by the modification of the taxonomy (step S46). As unchecked correspondence formulas exist (step S48/YES), the effect detection unit 213 executes the process of the step S44 to the next correspondence formula.

“Reserve (fixed liability)” used in the correspondence formula of the record in the second line in FIG. 11A appears in the list illustrated in FIG. 6C (step S44/YES). Thus, the effect detection unit 213 stores the record in the second line as the item to be affected by the modification of the taxonomy (step S46).

“Lease obligation (current liability)” used in the correspondence formula of the record in the third line in FIG. 11A does not appear in the list illustrated in FIG. 6B or 6C (step S44/NO). Thus, the effect detection unit 213 executes the process of the step S48. As unchecked correspondence formulas exist (step S48/YES), the effect detection unit 213 executes the process of the step S44 to the next correspondence formula. “Long-term debt” used in the correspondence formula of the record in the fourth line does not appear in the list illustrated in FIG. 6B or 6C (step S44/NO). Thus, the effect detection unit 213 executes the process of the step S48. As unchecked correspondence formulas exist (step S48/YES), the effect detection unit 213 executes the process of the step S44.

“Deferred tax liability” and “deferred tax liability for re-evaluation” used in the correspondence formula of the record in the fifth line in FIG. 11A appear in the list illustrated in FIG. 6C (step S44/YES). Thus, the effect detection unit 213 stores the record in the fifth line as the item to be affected by the modification of the taxonomy (step S46). As the unchecked correspondence formula does not exist (step S48/NO), the effect detection unit 213 ends the process.

In the flowchart illustrated in FIG. 5, the effect detection unit 213 outputs mapping definitions and verification/calculating formulas stored as items to be affected in the above process to the information processing apparatus 10a or 10b as the result of the effect detection (step S18). Then, the effect detection unit 213 ends the effect detection process.

In the specific example, the effect detection unit 213 outputs three mapping definitions, which are extracted in the above process, illustrated in FIG. 11B to the information processing apparatus 10a or 10b (step S18). The result of the effect detection output by the effect detection unit 213 is displayed on the display device provided to the information processing apparatus 10a or 10b. The user can see the result of the effect detection displayed on the display device, and check whether mapping definitions and verification/calculating formulas defined to the comparison-source taxonomy are affected by the modification of the taxonomy. Moreover, the user may determine whether it is necessary to review mapping definitions and verification/calculating formulas.

As described above, the effect detection device 20 in accordance with the embodiment, added, deleted and changed elements are extracted by comparing the comparison-source taxonomy with the comparison-subject taxonomy, and a parent element and a sibling element of added, deleted and change elements are extracted by using a Calculation link. Then, mapping definitions and verification/calculating formulas using added, deleted and change elements, a parent element and a sibling element are extracted from mapping definitions and verification/calculating formulas defined to the comparison-source taxonomy, and are output as items to be affected by the modification of the taxonomy. Thus, in a number of mapping definitions and verification/calculating formulas set to the taxonomy where many elements are defined, it is possible to reduce time taken for verifying the effect by the modification of the taxonomy, and prevent the occurrence of the mistake in the check, oversight and the like.

All examples and conditional language recited herein are intended for pedagogical purposes to aid the reader in understanding the invention and the concepts contributed by the inventor to furthering the art, and are to be constructed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the sprit and scope of the invention.

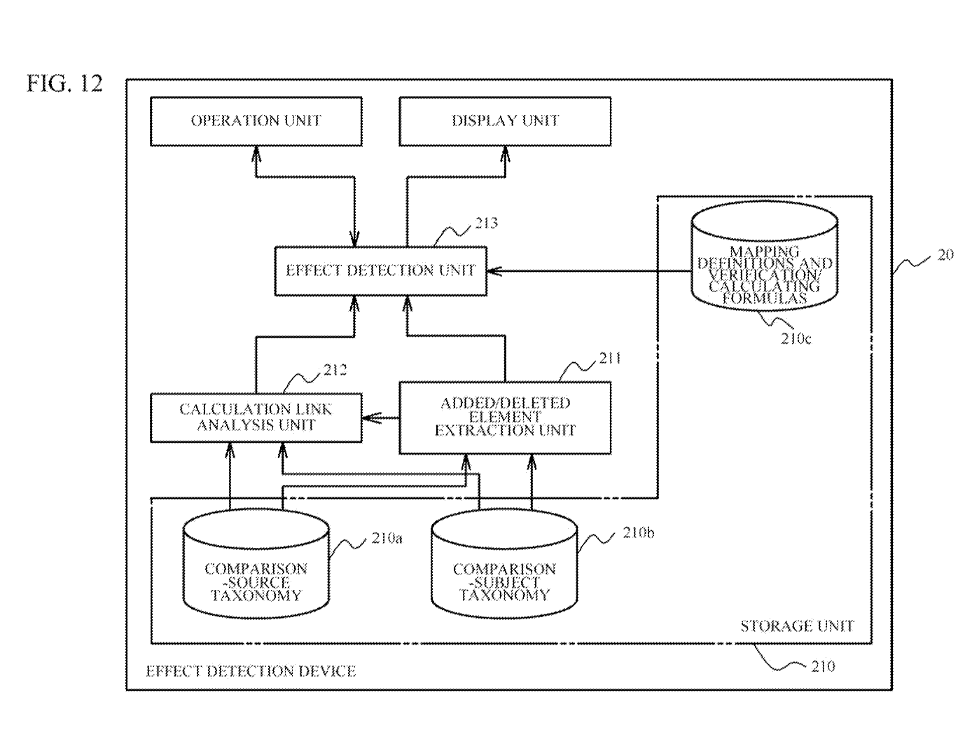

For example, in the above embodiment, the effect detection device 20 receives the instruction for executing the effect detection process from the information processing apparatus 10a or 10b, and outputs the result of the effect detection to the information processing apparatus 10a or 10b. However, as illustrated in FIG. 12, the effect detection device 20 may include an operation unit and a display unit, receive an instruction for executing the effect detection process from the user via the operation unit, and display the result of the effect detection on the own display unit. Accordingly, the user may execute the effect detection process and check the result without connecting the effect detection device 20 to the information processing apparatus 10a or 10b.

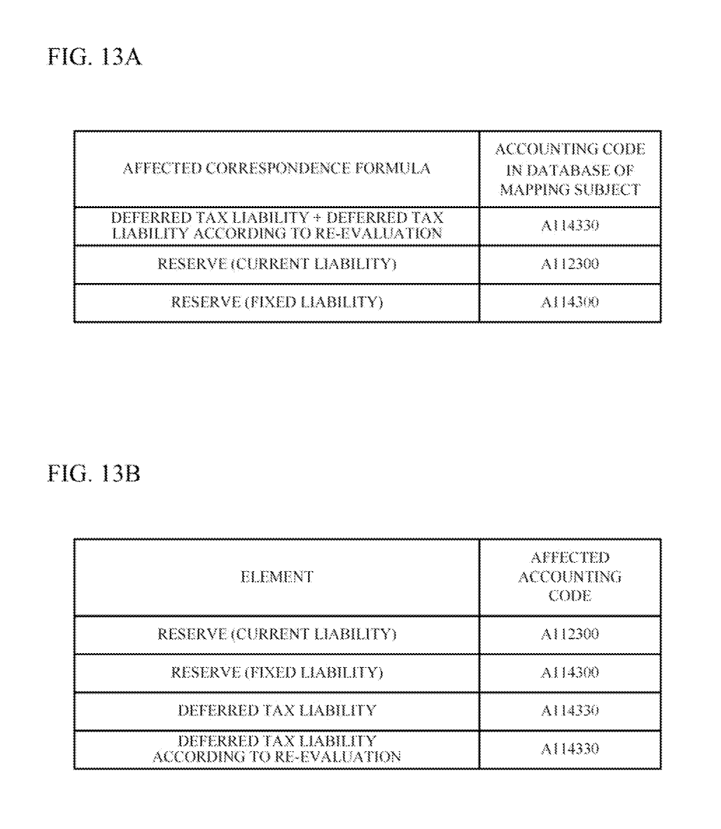

In the above embodiment, detected correspondence formulas are outputted as the result of the effect detection in the order of mapping definitions, but it is possible to output the correspondence formulas as the result of the effect detection based on the number of elements used in each correspondence formula. For example, as illustrated in FIG. 13A, “deferred tax liability and deferred tax liability for re-evaluation” which uses the largest number of elements included in lists illustrated in FIG. 6B and FIG. 6C may output at the top. Accordingly, the user may check the degree of the effect from mapping definitions and verification/calculating formulas which may be most affected by the modification of the taxonomy.

Functions that the above effect detection device has can be achieved by a computer. In that case, programs in which contents of the process of the function that the effect detection device has are provided. Above processing function are achieved on the computer by executing the programs by the computer. The program describing the content of the process may be stored in the storage medium which is readable by the computer.

When distributing the program, for example, a portable storage medium such as DVD (Digital Versatile Disc) and CD-ROM (Compact Disc Read Only Memory) in which the programs are stored is in sale. Moreover, it is possible to store the program in the storage device of the server computer, and transfer the program to another computer from the server computer via the network.

A computer executing a program stores the program stored in the portable storage medium or the program transferred from the server computer in its own storage device, for example. The computer reads the program from its own storage device, and executes the process according to the program. The computer may read the program from the portable storage medium directly, and executes the process according to the program. The computer may executes a process according to received program in response to the transfer of the program from the server computer.

A server computer coupled to a communication network such as an internet may be the above effect detection device, and provide a service of a effect detection to the communication device such as a personal computer, which is connected to the server computer, from the server computer (ASP (Application Service Provider)).

In the above embodiment, the effect detection device 20 receives and transmits data from and to the information processing apparatuses 10a and 10b via the network 30. However, the effect detection device 20 may be connected to the information processing apparatuses 10a and 10b directly (local connection) and may receive and transmit data. Moreover, in the above embodiment, a Calculation link is used for extracting a parent element and a sibling element, but a Presentation link and a Definition link may be also used.

What is claimed is:

1. An effect detection device comprising:
a first extraction unit configured to compare first document-structure definition information with second document-structure definition information, and extract at least one of an element added to the first document-structure definition information, an element changed in the first document-structure definition information, and an element deleted from the first document-structure definition information, the first document-structure definition information and the second document-structure definition information defining a structured document;
a second extraction unit configured to extract an element which is in a parent-child relationship or a sibling relationship with an element extracted by the first extraction unit from hierarchy definition documents defining a relation between elements with a hierarchy structure, the hierarchy definition documents being provided to the first document-structure definition information and the second document-structure definition information respectively; and
a detection unit configured to detect and output items defined by using at least one of the element extracted by the first extraction unit and an element extracted by the second extraction unit.

2. The effect detection device according to claim 1, wherein the detection unit changes an output order of detected items based on the number of elements which are used for a definition of the item and extracted by the first extraction unit and the number of elements which are used for a definition of the item and extracted by the second extraction unit.

3. The effect detection device according to claim 1, wherein the detection unit outputs detected items in respect to elements extracted by the first extraction unit and elements extracted by the second extraction unit.

4. The effect detection device according to claim 1, further comprising a display unit that displays items that the detection unit outputs.

5. A computer-readable, non-transitory medium storing a program that causes a computer to execute a process, the process comprising:
comparing first document-structure definition information with second document-structure definition information, the first document-structure definition information and the second document-structure definition information defining a structured document;
extracting at least one of an element added to the first document-structure definition information, an element changed in the first document-structure definition information, and an element deleted from the first document-structure definition information;
extracting an element which is in a parent-child relationship or a sibling relationship with an element extracted by the first extraction unit from hierarchy definition documents defining a relation between elements with a hierarchy structure, the hierarchy definition documents being provided to the first document-structure definition information and the second document-structure definition information respectively; and
outputting items defined by using at least one of extracted elements.

6. An effect detection method executed by a computer, the effect detection method comprising:
comparing first document-structure definition information with a second document-structure definition information, the first document-structure definition information and the second document-structure definition information defining a structured document;
extracting at least one of an element added to the first document-structure definition information, an element changed in the first document-structure definition information, and an element deleted from the first document-structure definition information;
extracting an element which is in a parent-child relationship or a sibling relationship with a element extracted by the first extraction unit from hierarchy definition documents defining a relation between elements with a hierarchy structure, the hierarchy definition documents being provided to the first document-structure definition information and the second document-structure definition information respectively; and
outputting items defined by using at least one of extracted elements.
